(19) United States
(12) Patent Application Publication
(10) Pub. No.: US 2026/0240308 A1
(43) Pub. Date: Aug. 20, 2026

(54) Mobile Electronic Device Strap Stand

(71) Applicant: Shenhuanya Technology (Shenzhen) Co., Ltd, Guangdong (CN)

(72) Inventor: Zhiwei ZHU, Guangdong (CN)

(73) Assignee: Shenhuanya Technology (Shenzhen) Co., Ltd, Guangdong (CN)

(21) Appl. No.: 19/057,768

(22) Filed: Feb. 19, 2025

(51) Int. Cl. A45F 5/10; A45F 5/00; F16M 11/04; H01F 7/02

(52) U.S. Cl. CPC A45F 5/10; F16M 11/041; H01F 7/0252; A45F 2005/006; F16M 2200/028

(57) ABSTRACT

The present disclosure provides a mobile electronic device strap stand, comprising a stand body and a flexible strap. The stand body is provided with a groove-shaped slide rail, and a sliding member is disposed within the groove-shaped slide rail and is slidable back and forth within the groove-shaped slide rail. The flexible strap is located on one side of the stand body and has a first end and a second end. The first end of the flexible strap is connected to the stand body, while the second end extends to the sliding member. A first connector is interposed between the sliding member and the second end of the flexible strap.

### TECHNICAL FIELD

The present disclosure relates to the technical field of electronic device supports, particularly to a mobile electronic device strap stand.

### BACKGROUND

Mobile electronic devices refer to portable devices that rely on battery power, can be carried around, and have electronic functions, including smartphones, tablets, handheld game consoles, e-readers, etc.

Since mobile electronic devices usually do not come with their own supports, they are not easy to place on a table or hold in hand. Therefore, many detachable electronic device supports have gradually appeared on the market to help users better use mobile electronic devices.

For example, a Chinese patent with the publication number CN219145427U discloses a new type of phone support. The support of this patent can be magnetically attached to the shell of the electronic device, and by setting a flexible strap that can arch, users can insert their fingers into the strap, making it easier to hold the electronic device. At the same time, the arched flexible strap can act as a support leg, providing support for the electronic device when the electronic device is placed on a table.

However, the aforementioned patent has some shortcomings. The flexible strap of the patent is connected to the sliding member through adhesion, which is not strong enough and is prone to breakage after long-term use. Additionally, the patent lacks a fixing function. When the flexible strap arches, the sliding member may slide, making it difficult to maintain the arched state of the flexible strap.

Therefore, there is a need to propose a new type of electronic device stand to address the issues mentioned above.

### SUMMARY

The present disclosure provides a mobile electronic device strap stand to solve the problems raised in the background technology.

To achieve the above-mentioned objectives of the disclosure, the following technical solutions are adopted:

A mobile electronic device strap stand includes a stand body and a flexible strap, wherein the stand body is provided with a groove-shaped slide rail, and a sliding member is disposed within the groove-shaped slide rail and is slidable back and forth within the groove-shaped slide rail; and the flexible strap is located on one side of the stand body and has a first end and a second end, wherein the first end of the flexible strap is connected to the stand body, while the second end extends to the sliding member; and a first connector is interposed between the sliding member and the second end of the flexible strap, and the sliding member and the flexible strap are interconnected through the first connector; and when the sliding member slides back and forth within the groove-shaped slide rail, the flexible strap is arched or straightened by the sliding member; and the groove-shaped slide rail is sequentially provided with a plurality of first positioning parts along a sliding direction of the sliding member, and the sliding member is provided with second positioning parts that cooperate with the first positioning parts; and after the sliding member slides, the second positioning parts are selectively locked with some of the first positioning parts, thereby maintaining the flexible strap in an arched or straightened state.

The present disclosure further provides a mobile electronic device strap stand, which includes a stand body and a flexible strap, wherein the stand body is provided with a groove-shaped slide rail, a sliding member is disposed in the groove-shaped slide rail, and the sliding member is slidable back and forth within the groove-shaped slide rail; and the flexible strap is located on one side of the stand body and has a first end and a second end, wherein the first end of the flexible strap is connected to the stand body, and the second end is attached to the sliding member; and when the sliding member slides back and forth within the groove-shaped rail, the flexible strap is arched or straightened by the sliding member; and the groove-shaped rail is sequentially provided with a plurality of first positioning parts along a sliding direction of the sliding member, and the sliding member is provided with second positioning parts that cooperate with the first positioning parts; and after the sliding member slides, the second positioning parts are selectively locked with some of the first positioning parts, thereby maintaining the flexible strap in an arched or straightened state.

The present disclosure further provides a mobile electronic device strap stand, which includes a stand body and a flexible strap, wherein the stand body is provided with a groove-shaped slide rail, a sliding member is disposed within the groove-shaped slide rail, and the sliding member is slidable back and forth within the groove-shaped slide rail; and the flexible strap is located on one side of the stand body and has a first end and a second end, wherein the first end of the flexible strap is connected to the stand body, while the second end extends to the sliding member; and a first connector is interposed between the sliding member and the second end of the flexible strap, and the sliding member and the flexible strap are connected to each other through the first connector; and when the sliding member slides back and forth within the groove-shaped slide rail, the flexible strap is arched or straightened by the sliding member.

### BRIEF DESCRIPTION OF DRAWINGS

The drawings, which form a part of this application, are intended to provide a further understanding of the present disclosure. The illustrative embodiments and the descriptions thereof are used to explain the present disclosure and do not constitute an improper limitation of the present disclosure. In the drawings:

FIG. 1 is a schematic structural diagram of the present disclosure;

FIG. 2 is an enlarged view of section A in FIG. 1;

FIG. 3 is a schematic diagram of the structure from another perspective of the disclosure;

FIG. 4 is a cross-sectional view of the disclosure;

FIG. 5 is an enlarged view of section B in FIG. 4;

FIG. 6 is a schematic diagram of the sliding member of the disclosure;

FIG. 7 is a schematic diagram of the first connector of the disclosure;

FIG. 8 is a schematic diagram of another embodiment of the disclosure;

FIG. 9 is a schematic structural diagram of another perspective of another embodiment of the present disclosure.

Reference signs: Stand body (100); Strip part (110); Grooved-shaped slide rail (111); Arc-shaped groove (112); Guiding through slot (113); Annular part (120); Flexible strap (200); First end (210); Second end (220); Sliding member (300); Buffer chamber (310); Elastic side wall (320); Arc-shaped protrusion (330); Guiding protrusion (340); First connector (400); Head (410); Insertion part (420); Second connector (500); Magnet (600).

### DESCRIPTION OF EMBODIMENTS

The technical solution in the embodiment of the present disclosure will be clearly and completely described below with reference to the drawings. Obviously, the described embodiment is part of, rather than all of the embodiments of the present disclosure. The following description of at least one exemplary embodiment is illustrative in nature and is in no way intended to limit the present disclosure, its application or uses. Based on the embodiments in the present disclosure, all other embodiments obtained by those skilled in the art without creative work belong to the scope of protection of the present disclosure.

It should be noted that the terminology used here is only for describing specific embodiments, and is not intended to limit exemplary embodiments according to the present application. As used herein, the singular form is also intended to include the plural form unless the context clearly indicates otherwise. Furthermore, it should be appreciated that when the terms “comprising” and/or “including” are used in this specification, they specify the presence of features, steps, operations, devices, components and/or combinations thereof.

Unless otherwise specified, the relative arrangement of components and steps, numerical expressions and numerical values set forth in these embodiments do not limit the scope of the present disclosure. At the same time, it should be appreciated that for the convenience of description, the dimensions of various parts shown in the drawings are not drawn according to the actual scale relationship. Techniques, methods and equipment known to those skilled in the art may not be discussed in detail, but in appropriate cases, they should be regarded as part of the authorization specification. In all the examples shown and discussed herein, any specific values should be interpreted as illustrative, and not as limiting. Therefore, other examples of exemplary embodiments may have different values. It should be noted that similar numbers and letters indicate similar items in the following drawings, therefore once an item is defined in one drawing, it does not need to be further discussed in subsequent drawings.

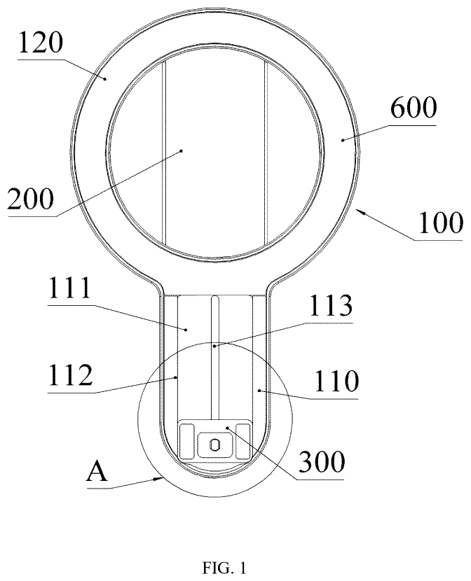

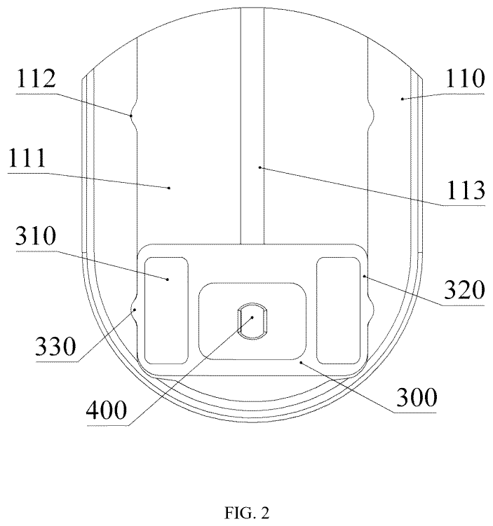

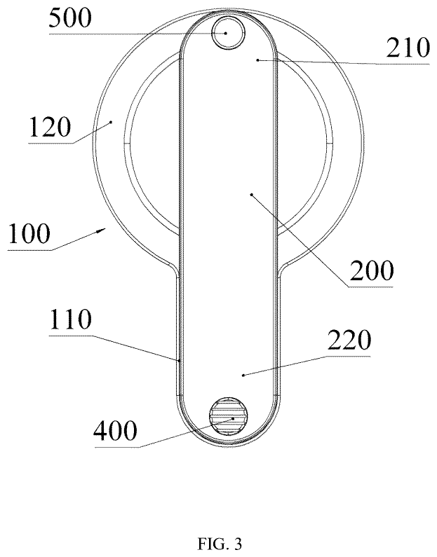

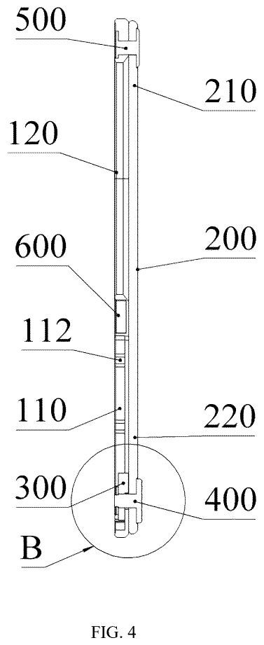

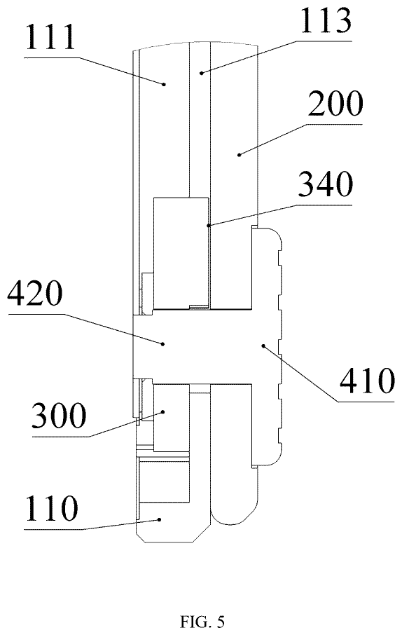

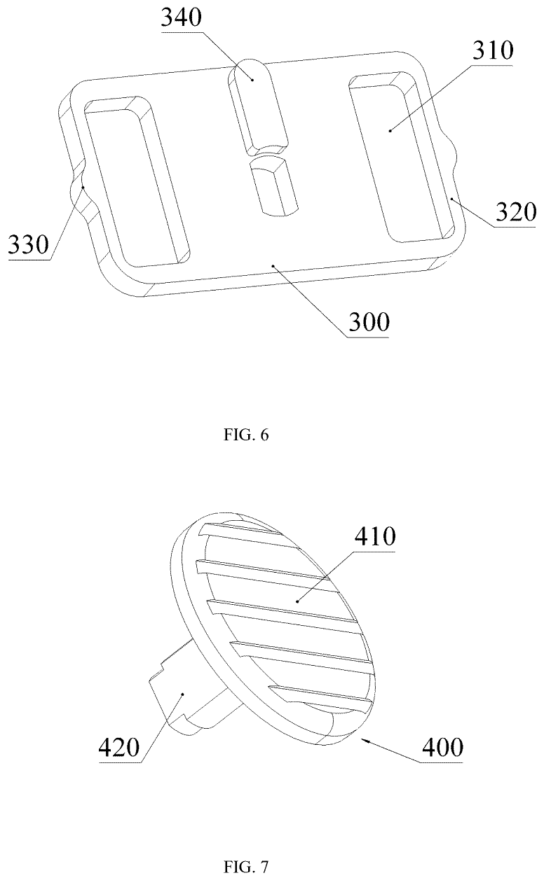

As shown in FIGS. 1 to 7, a mobile electronic device strap stand includes a stand body 100 and a flexible strap 200. The stand body 100 is provided with a groove-shaped slide rail 111, and a sliding member 300 is disposed within the groove-shaped slide rail 111. The sliding member 300 is slidable back and forth within the groove-shaped slide rail 111. The flexible strap 200 is located on one side of the stand body 100 and has a first end 210 and a second end 220. The first end 210 of the flexible strap 200 is connected to the stand body 100, while the second end 220 extends to the sliding member 300. A first connector 400 is interposed between the sliding member 300 and the second end 220 of the flexible strap 200, and the sliding member 300 and the flexible strap 200 are connected to each other through the first connector 400. When the sliding member 300 slides back and forth within the groove-shaped slide rail 111, the flexible strap 200 can change its shape accordingly, being arched or straightened by the sliding member 300. By adjusting the position of the sliding member 300, the curvature of the flexible strap 200 can be controlled.

The groove-shaped slide rail 111 is sequentially provided with a plurality of first positioning parts along the sliding direction of the sliding member 300, and the sliding member 300 is provided with second positioning parts that cooperate with the first positioning parts. When the sliding member 300 slides, the second positioning parts are selectively locked with some of the first positioning parts, thereby maintaining the flexible strap 200 in an arched or straightened state. When the sliding member 300 slides to a certain first positioning part, the second positioning part is locked with it, thus maintaining the flexible strap 200 in the desired predetermined state. This design can effectively prevent the flexible strap 200 from loosening or shifting during use, ensuring the stability and practicality of the stand.

Please refer to FIGS. 1, 2, and 6. In this embodiment, the first positioning part is an arc-shaped groove 112. The number of arc-shaped grooves 112 is not specifically limited, and preferably, there are six arc-shaped grooves 112. The arc-shaped grooves 112 are provided on the inner surface of the groove-shaped slide rail 111, disposed symmetrically in pairs, and evenly distributed along the length direction of the groove-shaped slide rail 111, forming a plurality of positioning points. The second positioning part is an arc-shaped protrusion 330. There are two arc-shaped protrusions 330, symmetrically distributed on both sides of the sliding member 300. The arc-shaped protrusions 330 is capable of sliding into or out of the arc-shaped grooves 112. The shape of the arc-shaped protrusions 330 matches that of the arc-shaped grooves 112, and their curvature is slightly smaller than that of the arc-shaped grooves 112, so that the arc-shaped protrusions 330 can smoothly slide into or out of the arc-shaped grooves 112 when the sliding member 300 slides.

The sliding member 300 is provided with a buffer chamber 310, which has an elastic side wall 320. The arc-shaped protrusion 330 is set on the elastic side wall 320, which has a certain elastic deformation capability. When the arc-shaped protrusion 330 slides out of the arc-shaped groove 112, the elastic side wall 320 bends towards the buffer chamber 310 and undergoes elastic deformation. When the sliding member 300 slides to a certain arc-shaped groove 112, the arc-shaped protrusion 330 automatically snaps into the arc-shaped groove 112 under the action of the elastic side wall 320, achieving the fixed locking of the sliding member 300. When it is necessary to release the sliding member 300 from locking, only an external force is needed to push the sliding member 300, at which point the elastic side wall 320 is squeezed and undergoes elastic deformation towards the buffer chamber 310, allowing the arc-shaped protrusion 330 to slide out of the arc-shaped groove 112, and the sliding member 300 can continue to move along the slide rail.

The matching design of the arc-shaped protrusion 330 and the arc-shaped groove 112 achieves the multi-position locking function of the sliding member 300 and ensures the stability of the flexible strap 200 in both arched and straight states. For example, when the flexible strap 200 is arched by the sliding member 300, the arc-shaped protrusion 330 snaps into the corresponding arc-shaped groove 112, preventing the sliding member 300 from sliding due to external forces, thus maintaining the arched state of the flexible strap 200. When the flexible strap 200 needs to be straightened, the sliding member 300 moves to another arc-shaped groove 112, and the arc-shaped protrusion 330 snaps in again, ensuring the flexible strap 200 is in a straightened state. When the sliding member 300 moves within the groove-shaped slide rail 111, the flexible strap 200 is driven to arch or straighten, thereby achieving support or grip functions.

In another embodiment (not shown), the elastic part can also be a bendable elastic rod, with the arc-shaped protrusion 330 at the end of the elastic rod. When the arc-shaped protrusion 330 slides out of the arc-shaped groove 112, the elastic rod bends and undergoes elastic deformation, allowing the arc-shaped protrusion 330 to slide out of the arc-shaped groove 112.

In another embodiment (not shown), the elastic part can also be an elastic telescopic rod, the second positioning part is set on the elastic telescopic rod, and the sliding member 300 does not need a buffer chamber 310 and an elastic side wall 320. The elastic telescopic rod is locked with the first positioning part. When the sliding member 300 slides, the elastic telescopic rod slides to a certain first positioning part and pops out to be locked into the first positioning part. To unlock, only an external force is needed to push the sliding member 300, causing the elastic telescopic rod to compress and retract towards the sliding member 300, disengaging from the first positioning part, allowing the sliding member 300 to continue sliding, thus achieving multi-position locking of the sliding member 300.

In other embodiments, the first positioning part and the second positioning part can also be fixed and locked through structures such as magnetic fixation and spring buckle fixation. When magnetic fixation is used, the first positioning part is a magnetic material (such as a permanent magnet or electromagnet) embedded in the groove-shaped slide rail 111, and the second positioning part is a magnetic element (such as an iron piece or magnet) set on the sliding member 300. When the sliding member 300 moves to the target position, the magnetic element of the second positioning part and the magnetic material of the first positioning part generate a magnetic force, thus achieving the fixed locking of the sliding member 300. When spring buckle fixation is used, the first positioning part is an arc-shaped groove 112 in the groove-shaped slide rail 111, and the second positioning part is a spring buckle set on the sliding member 300. The spring buckle includes a buckle head and a spring component, and the buckle head can retract under the action of the spring. When the sliding member 300 moves to a target position, the buckle head pops out under the action of the spring to be locked into the groove, achieving the fixed locking of the sliding member 300. Magnetic fixation and spring buckle fixation can also be used in combination. For example, the sliding member 300 is simultaneously equipped with a magnetic element and a spring buckle, and the groove-shaped slide rail 111 is correspondingly equipped with a magnetic material point and a slot. When the sliding member 300 moves to a target position, the magnetic element and the magnetic material point generate a magnetic force, and the spring buckle is locked into the slot, achieving double fixation.

In another embodiment (not shown), the first positioning part and the second positioning part can be canceled, allowing the sliding member 300 to slide freely back and forth within the groove-shaped slide rail 111.

Please refer to FIGS. 1 to 7. In this embodiment, a guiding through slot 113 is provided along the sliding direction of the sliding member 300 within the groove-shaped slide rail 111. The guiding through slot 113 is a long channel that penetrates the stand body 100. The first connector 400 includes a head 410 and an insertion part 420. The head 410 is circular with a diameter larger than the width of the guiding through slot 113. The upper surface of the head 410 is provided with anti-slip patterns to increase friction, and the lower surface of the head 410 adheres to the outer surface of the flexible strap 200. The insertion part 420 has a diameter slightly smaller than the width of the guiding through slot 113. The insertion part 420 sequentially passes through the flexible strap 200 and the guiding through slot 113, and its end is fixed to the sliding member 300 through interference fit. The insertion part 420 is slidably connected to the guiding through slot 113 and can move back and forth within the guiding through slot 113.

In other embodiments (not shown), the first connector 400 and the sliding member 300 can also be connected through threaded connection, snap connection, magnetic connection, quick-release pin connection, and rivet connection. For threaded connection, the sliding member 300 and the first connector 400 are provided with threaded holes and external threads respectively. For snap connection, the end of the insertion part 420 of the first connector 400 is provided with an elastic snap, and the corresponding position of the sliding member 300 is provided with a snap slot. During installation, after the insertion part 420 is inserted into the sliding member 300, the elastic snap is deformed by compression until it snaps into the snap slot and automatically pops up for locking. For magnetic connection, the end of the insertion part 420 is embedded with a magnetic element (such as a permanent magnet or iron piece), and the corresponding position of the sliding member 300 is provided with a matching magnetic material (such as an iron piece or magnet). During installation, when the insertion part 420 approaches the sliding member 300, the magnetic element is automatically attracted to the magnetic material for fixation. For quick-release pin connection, the end of the insertion part 420 is provided with a pin hole, and the corresponding position of the sliding member 300 is provided with a quick-release pin. During installation, after the insertion part 420 is inserted into the sliding member 300, the quick-release pin passes through the pin hole for locking.

Please refer to FIGS. 1, 5, and 6. In this embodiment, the sliding member 300 is provided with a guiding protrusion 340. The guiding protrusion 340 is a columnar structure integrally formed with the main body of the sliding member 300, and its length direction is consistent with the extension direction of the guiding through slot 113. The guiding protrusion 340 extends into the guiding through slot 113 and is slidably connected to the inner wall of the guiding through slot 113.

In other embodiments (not shown), the contact surfaces between the sliding member 300 and the groove-shaped slide rail 111, and between the guiding protrusion 340 and the guiding through slot 113, can be covered with low-friction coefficient materials, such as polytetrafluoroethylene coating or ceramic plating, to further reduce sliding resistance and make sliding smoother.

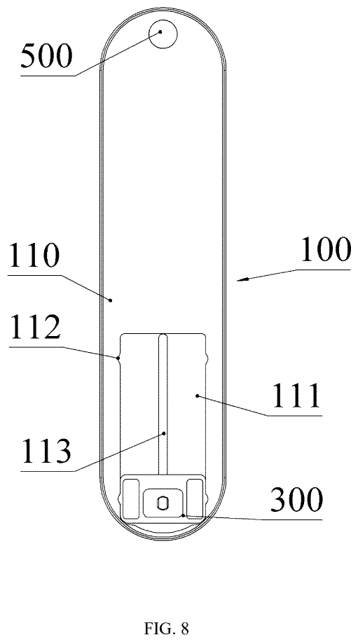

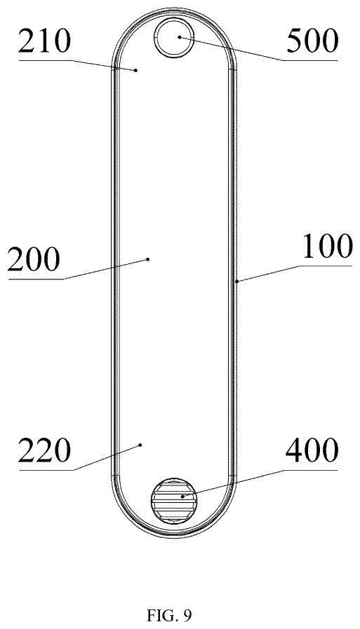

Please refer to FIGS. 8 and 9. In this embodiment, the stand body 100 includes a strip part 110, whose cross-sectional shape is rectangular. The groove-shaped slide rail 111 is set on the strip part 110 and extends along the length direction of the strip part 110. A plurality of first positioning parts are uniformly disposed along the length direction of the groove-shaped slide rail 111. Both the sliding member 300 and the groove-shaped slide rail 111 are made of metal materials, such as aluminum alloy or stainless steel. The first end 210 of the flexible strap 200 is installed at one end of the strip part 110 away from the sliding member 300, and a second connector 500 is inserted between the first end 210 of the flexible strap 200 and the strip part 110, connecting the flexible strap 200 to the stand body 100 through the second connector 500, which is a rivet. The material of the flexible strap 200 is preferably a highly elastic and wear-resistant material, such as silicone, TPU, leather, woven strap, and cloth strap, ensuring that it is not prone to breakage or deformation during long-term use. The sliding member 300 can selectively slide towards the first end 210 or away from the first end 210. A magnet 600 is embedded within the strip part 110, preferably a rare earth permanent magnet (such as neodymium iron boron magnet), and the stand body 100 is magnetically attached to the mobile electronic device through the magnet 600.

In other embodiments (not shown), the sliding member 300 and the groove-shaped slide rail 111 can also be made of wear-resistant materials such as resin, plastic, or ceramic.

Please refer to FIGS. 1 to 4. In this embodiment, the stand body 100 also includes an annular part 120 connected to the strip part 110. The first end 210 of the flexible strap 200 is installed at one end of the annular part 120 away from the sliding member 300, and a second connector 500 is inserted between the first end 210 of the flexible strap 200 and the annular part 120, connecting the flexible strap 200 to the annular part 120 through the second connector 500, which is a rivet. The sliding member 300 can selectively slide towards the first end 210 or away from the first end 210. A magnet 600 is embedded inside the annular part 120, preferably a rare earth permanent magnet 600 (such as neodymium iron boron magnet), making the annular part 120 more closely fit the magnetic charging ring on the back of the electronic device, ensuring that the stand body 100 can firmly adhere to the back of the mobile electronic device.

In other embodiments (not shown), the first end 210 of the flexible strap 200 and the stand body 100 can also be connected by screws, snap fasteners, and button fasteners.

In another embodiment (not shown), the surface of the stand body 100 that comes into contact with the electronic device is provided with a film that matches the shape of the stand body. The film is made of highly adhesive silicone or 3M adhesive material, and it has the characteristic of being repeatedly adhesive, allowing users to adjust the position of the stand for multiple times without completely losing its adhesiveness; the stand body 100 can be adhered to the electronic device or the protective case of the electronic device.

In other embodiments (not shown), the shape of the stand body 100 can also be T-shaped, cross-shaped, or other geometric shapes to adapt to different usage scenarios and device types.

In summary, it can be seen from the above description that the present disclosure achieves the following technical effects:

By arranging a plurality of first positioning parts in the groove-shaped slide rail 111 of the stand body 100 and using them in conjunction with the second positioning parts on the sliding member 300, the flexible strap 200 can be firmly locked in different states; when the sliding member 300 slides in the groove-shaped slide rail 111, the locking between the second positioning part and the first positioning part effectively maintains the stable form of the flexible strap 200 (such as arched or straightened), avoiding the problem of loosening or shifting of the flexible strap 200 during use, thereby improving the practicality and stability of the stand; by setting a buffer chamber 310 and elastic side wall 320 at the position of the second positioning part, users can easily adjust the form of the flexible strap 200, and the sliding member 300 can be locked or released without excessive external force, effectively avoiding overly complex operational steps and improving the convenience and user experience of the stand.

In the description of the present disclosure, it should be appreciated that directional terms such as “front, rear, up, down, left, right”, “horizontal, vertical, perpendicular, horizontal” and “top, bottom” etc. indicate the orientation or positional relationship based on the orientation or positional relationship shown in the drawings, and are only for the convenience of describing the present disclosure and simplifying the description. In the absence of a contrary explanation, these directional terms do not indicate or imply that the device or element referred to must have a specific orientation or be constructed and operated in a specific orientation, and therefore should not be understood as limiting the scope of protection of the present disclosure; the directional terms “inside, outside” refer to the inside and outside relative to the contour of each component itself.

For the convenience of description, spatial relative terms such as “on . . . ”, “above . . . ”, “on the upper surface of . . . ”, “upper” etc. may be used here to describe the spatial positional relationship of a device or feature with other devices or features as shown in the drawings. It should be appreciated that spatial relative terms are intended to encompass different orientations of the device in use or operation other than the orientation described in the drawings. For example, if the device in the drawing is inverted, the device described as “above other devices or structures” or “on other devices or structures” will subsequently be positioned as “below other devices or structures” or “under other devices or structures”. Thus, the exemplary term “above” can include both “above” and “below” orientations. The device can also be positioned in other different ways (rotated 90 degrees or in other orientations), and the spatial relative descriptions used here should be interpreted accordingly.

In addition, it should be noted that the use of terms such as “first”, “second” etc. to define components is for the convenience of distinguishing the corresponding components. Unless otherwise stated, the above terms have no special meaning, and therefore should not be understood as limiting the scope of protection of the present disclosure.

The above description is only a preferred embodiment of the present disclosure and is not intended to limit the present disclosure. For those skilled in the art, the present disclosure can have various modifications and changes. Any modifications, equivalent replacements, improvements etc. made within the spirit and principles of the present disclosure should be included within the scope of protection of the present disclosure.

What is claimed is:

1. A mobile electronic device strap stand, comprising a stand body and a flexible strap, wherein
the stand body is provided with a groove-shaped slide rail, and a sliding member is disposed within the groove-shaped slide rail and is slidable back and forth within the groove-shaped slide rail; and
the flexible strap is located on one side of the stand body and has a first end and a second end, wherein the first end of the flexible strap is connected to the stand body, while the second end extends to the sliding member; and
a first connector is interposed between the sliding member and the second end of the flexible strap, and the sliding member and the flexible strap are interconnected through the first connector; and
when the sliding member slides back and forth within the groove-shaped slide rail, the flexible strap is arched or straightened by the sliding member; and
the groove-shaped slide rail is sequentially provided with a plurality of first positioning parts along a sliding direction of the sliding member, and the sliding member is provided with second positioning parts that cooperate with the first positioning parts; and
after the sliding member slides, the second positioning parts are selectively locked with some of the first positioning parts, thereby maintaining the flexible strap in an arched or straightened state.

2. The mobile electronic device strap stand according to claim 1, wherein the first positioning part is an arc-shaped groove, and the arc-shaped groove is provided on an inner surface of the groove-shaped slide rail.

3. The mobile electronic device strap stand according to claim 2, wherein the second positioning part is an arc-shaped protrusion, and the arc-shaped protrusion is capable of sliding into or out of the arc-shaped groove.

4. The mobile electronic device strap stand according to claim 3, wherein the sliding member is provided with a buffer chamber, the buffer chamber has an elastic side wall, and the arc-shaped protrusion is disposed on the elastic side wall; and
when the arc-shaped protrusion slides out of the arc-shaped groove, the elastic side wall bends toward the buffer chamber and undergoes elastic deformation.

5. The mobile electronic device strap stand according to claim 1, wherein a guiding through slot is provided along the sliding direction of the sliding member in the groove-shaped slide rail, and the first connector comprises a head and an insertion part, wherein the head is attached to the outer surface of the flexible strap, the insertion part sequentially passes through the flexible strap and the guiding through slot and is inserted into the sliding member, and the insertion part is slidably connected to the guiding through slot.

6. The mobile electronic device strap stand according to claim 5, wherein the sliding member is provided with a guiding protrusion, the guiding protrusion extends into the guiding through slot and is slidably connected to the guiding through slot.

7. The mobile electronic device strap stand according to claim 1, wherein the stand body comprises a strip part, and the groove-shaped slide rail is disposed on the strip part and extends along a length direction of the strip part.

8. The mobile electronic device strap stand according to claim 7, wherein the plurality of the first positioning parts are uniformly disposed along the length direction of the groove-shaped slide rail, and the sliding member and the groove-shaped slide rail are both made of metal.

9. The mobile electronic device strap stand according to claim 7, wherein the first end of the flexible strap is installed at an end of the strip part away from the sliding member, and the sliding member selectively slides towards the first end or away from the first end.

10. The mobile electronic device strap stand according to claim 9, wherein a magnet is embedded in the strip part, and the stand body is attracted to a mobile electronic device through the magnet.

11. The mobile electronic device strap stand according to claim 7, wherein the stand body further comprises an annular part connected to the strip part, the first end of the flexible strap is installed on the annular part, and the sliding member selectively slides towards the first end or away from the first end.

12. The mobile electronic device strap stand according to claim 11, wherein a magnet is embedded inside the annular part, and the stand body is attracted to the mobile electronic device through the magnet.

13. A mobile electronic device strap stand, comprising a stand body and a flexible strap, wherein
the stand body is provided with a groove-shaped slide rail, a sliding member is disposed in the groove-shaped slide rail, and the sliding member is slidable back and forth within the groove-shaped slide rail; and
the flexible strap is located on one side of the stand body and has a first end and a second end, wherein the first end of the flexible strap is connected to the stand body, and the second end is attached to the sliding member; and
when the sliding member slides back and forth within the groove-shaped rail, the flexible strap is arched or straightened by the sliding member; and
the groove-shaped rail is sequentially provided with a plurality of first positioning parts along a sliding direction of the sliding member, and the sliding member is provided with second positioning parts that cooperate with the first positioning parts; and
after the sliding member slides, the second positioning parts are selectively locked with some of the first positioning parts, thereby maintaining the flexible strap in an arched or straightened state.

14. The mobile electronic device strap stand according to claim 13, wherein the first positioning part is an arc-shaped groove, and the arc-shaped groove is provided on an inner surface of the groove-shaped rail.

15. The mobile electronic device strap stand according to claim 14, wherein the second positioning part is an arc-shaped protrusion, and the arc-shaped protrusion is capable of sliding into or out of the arc-shaped groove.

16. The mobile electronic device strap stand according to claim 15, wherein the sliding member is provided with an elastic part, and the arc-shaped protrusion is disposed on the elastic part; and
when the arc-shaped protrusion slides out of the arc-shaped groove, the elastic part undergoes elastic deformation and allows the arc-shaped protrusion to slide out of the arc-shaped groove.

17. The mobile electronic device strap stand according to claim 16, wherein the sliding member is provided with a buffer chamber having an elastic side wall, the elastic side wall is configured as the elastic part, and the arc-shaped protrusion is disposed on the elastic side wall; and
when the arc-shaped protrusion slides out of the arc-shaped groove, the elastic side wall bends toward the buffer chamber and undergoes elastic deformation.

18. A mobile electronic device strap stand, comprising a stand body and a flexible strap, wherein
the stand body is provided with a groove-shaped slide rail, a sliding member is disposed within the groove-shaped slide rail, and the sliding member is slidable back and forth within the groove-shaped slide rail; and
the flexible strap is located on one side of the stand body and has a first end and a second end, wherein the first end of the flexible strap is connected to the stand body, while the second end extends to the sliding member; and
a first connector is interposed between the sliding member and the second end of the flexible strap, and the sliding member and the flexible strap are connected to each other through the first connector; and
when the sliding member slides back and forth within the groove-shaped slide rail, the flexible strap is arched or straightened by the sliding member.

19. The mobile electronic device strap stand according to claim 18, wherein a guiding through slot is provided along the sliding direction of the sliding member within the groove-shaped slide rail, and the first connector comprises a head and an insertion part, wherein the head is attached to an outer surface of the flexible strap, the insertion part sequentially passes through the flexible strap and the guiding through slot and is inserted into the sliding member, and the insertion part is slidably connected to the guiding through slot.

20. The mobile electronic device strap stand according to claim 19, wherein the sliding member is provided with a guiding protrusion, the guiding protrusion extends into the guiding through slot and is slidably connected to the guiding through slot.
